(19) United States
(12) Patent Application Publication
(10) Pub. No.: US 2026/0087552 A1
(43) Pub. Date: Mar. 26, 2026

(54) SYSTEMS AND METHODS FOR IMPROVING ACCURACY OF PLANS FOR ALLOCATING RESOURCES

(71) Applicant: FMR LLC, Boston, MA (US)

(72) Inventors: Thomas Phair CHURCHILL, Andover, MA (US); Timothy LONGFIELD, Raleigh, NC (US); Satya Prakash SUTAR, Apex, NC (US)

(21) Appl. No.: 18/897,371

(22) Filed: Sep. 26, 2024

(51) Int. Cl. G06Q 40/06; G06Q 10/0631

(52) U.S. Cl. CPC G06Q 40/06; G06Q 10/06315

(57) ABSTRACT

Systems and methods are described for improving accuracy of plans for allocating resources. A server computing device may be configured to determine a recommended plan that allows a user to accomplish his or her objective or goal. The recommended plan may be selected from one or more plan options that are generated by inputting a machine learning model with user data from one or more databases and one or more plan templates. The recommended plan determines a specific amount of resources to transfer from a first user account to a second user account at a predetermined time interval until the objective or goal is reached.

### TECHNICAL FIELD

This application relates generally to systems and methods, including computer program products, for improving accuracy of plans for allocating resources.

### BACKGROUND

Throughout history, there have always been economic crises, such as the Great Depression, the 1970's Energy Crisis, the Great Recession, the COVID-19 Recession, and the 2021-2023 worldwide inflation surge. Historically, during such times, the average person struggles with basic expenses such as groceries, rent (or mortgage) payments, and utility (e.g., electricity, water, gas, etc.) bills. However, the average person in the modern world struggles even more during such crises, since the number of expenses has expanded as result of advance technology and changing social conditions that bring about more expenses that were previously non-existent in the past. These expenses include bills related to telephone, internet, multiple membership or subscription services (e.g., gym, music, video, podcasts, etc.), student loans, car loans, insurance (e.g., health, car), and credit cards. It is no surprise that it is extremely difficult for the modern person to keep track of their expenses, and simultaneously manage resources (e.g., save money) for an objective or goal that such modern person may have.

Further exacerbating this struggle is the lifestyle of the modern person, which is fast paced due in part to modern technology allowing instant communication over long distances via multiple means (e.g., texting, phone, email, fax, television, internet, social media, etc.) and enabling long distance travel within a short amount of time (e.g., via high-speed rail, jet airplanes, automobiles). Vast amounts of information can travel quickly, thereby overwhelming the modern person who is always attempting to process the information received. Indeed, the modern person is constantly being blasted with information throughout the day. As such, the modern person comes home exhausted every night, without having the capacity to do mental chores. It is no surprise that the modern person has no time to evaluate or manage their financial situation. Consequently, many persons today struggle to meet their financial obligations, find it difficult to escape debt, or save money for an important goal.

### SUMMARY

The present disclosure, in one aspect, a computing (or computer) system comprising a server computing device having a memory for storing computer-executable instructions and a processor that executes the computer-executable instructions to: receive instructions, from the user, to generate a recommended plan based on an objective that is fulfilled after completion of one or more conditions, wherein the one or more conditions include a goal value and a target date of fulfilling the objective; retrieve user data from one or more databases; generate, via a machine learning model, one or more plan options based on the user data and one or more plan templates, wherein each plan option is associated with a transfer schedule that indicates one or more specific amount of resources to be transferred from a first user account to a second user account at one or more predetermined time intervals until the goal value is completed by the target date; determine, via the machine learning model, a confidence score for each plan option based on the user data and the associated transfer schedule, wherein the confidence score is associated with a probability that the user is capable of fulfilling the objective by adhering to the transfer schedule in the plan option; implement the recommended plan by moving resources from the first user account to the second user account according to the transfer schedule associated with the recommended plan until the objective is fulfilled, wherein the recommended plan is the plan option having the highest confidence score among the one or more plan options; and display planning graphics associated with the recommended plan, wherein the planning graphics includes a chart indicating a predicted total amount of resources accumulated in the second user account for each of the one or more predetermined time intervals and the one or more specific amount of resources that are predicted to be transferred to the second user account for each of the one or more predetermined time intervals.

The computer executable instructions cause the processor to perform further operations to: receive update user data from the one or more databases, wherein the updated user data is different from the user data; and analyze, via the machine learning model, the updated user data to determine whether to update a current recommended plan or to generate a new recommended plan. The computer executable instructions cause the processor to perform further operations to: determine, via the machine learning model, from the updated user data, that the circumstances of the user has changed sufficiently to warrant an update of a current transfer schedule; and generate, via the machine learning model, a new transfer schedule based on the goal value, the target date, the user data and the plan template used to generate the recommended plan, wherein the new transfer schedule is different from the transfer schedule of the current recommended plan. The computer executable instructions cause the processor to perform further operations to: display a notification on a user interface before the user, wherein the notification informs the user that the recommended plan remains the same, and indicates that the current transfer schedule is being replaced by the new transfer schedule. The computer executable instructions cause the processor to perform further operations to: determine, from the updated user data, that the circumstances of the user has changed sufficiently to warrant a new recommended plan; generate, via a machine learning model, one or more new plan options based on the updated user data and the one or more plan templates, wherein each new plan option is associated with a new transfer schedule that indicates one or more new specific amount of resources to be transferred from the first user account to the second user account at one or more new predetermined time intervals until the goal value is completed by a new target date; and determine, via the machine learning model, a new confidence score for each new plan option based on the updated user data and the associated new transfer schedule, wherein the new recommended plan is based on the plan option having the highest confidence score. The computer executable instructions cause the processor to perform further operations to: display a notification on a user interface before the user, wherein the notification informs the user that the current recommended plan is being replaced by a new recommended plan. The computer executable instructions cause the processor to perform further operations to: determine that the objective has been fulfilled after completion of the one or more conditions; display a notification on a user interface before the user that the user has fulfilled the objective by completing the one or more conditions associated with the objective.

The present disclosure, in another aspect, features a non-transitory computer-readable medium receive instructions, from a user, to generate a recommended plan based on an objective that is fulfilled after completion of one or more conditions, wherein the one or more conditions include a goal value and a target date of fulfilling the objective; retrieve user data from one or more databases; generate, via a machine learning model, one or more plan options based on the user data and one or more plan templates, wherein each plan option is associated with a transfer schedule that indicates one or more specific amount of resources to be transferred from a first user account to a second user account at one or more predetermined time intervals until the goal value is completed by the target date; determine, via the machine learning model, a confidence score for each plan option based on the user data and the associated transfer schedule, wherein the confidence score is associated with a probability that the user is capable of fulfilling the objective by adhering to the transfer schedule in the plan option; implement the recommended plan by moving resources from the first user account to the second user account according to the transfer schedule associated with the recommended plan until the objective is fulfilled, wherein the recommended plan is the plan option having the highest confidence score among the one or more plan options; and display planning graphics associated with the recommended plan, wherein the planning graphics includes a chart indicating a predicted total amount of resources accumulated in the second user account for each of the one or more predetermined time intervals and the one or more specific amount of resources that are predicted to be transferred to the second user account for each of the one or more predetermined time intervals.

The computer executable instructions cause the computing device to perform further operations to: display, after the one or more plan options are generated by the machine learning model, the one or more plan options on a user interface before the user, wherein the one or more displayed plan options include a confidence score associated with each plan option, wherein a plan option with the highest confidence score is indicated to the user as the recommended plan.

The computer executable instructions cause the computing device to perform further operations to: receive instructions from the user to select at least one of the one or more plan options displayed on the user interface before the user; and determine the recommended plan as the plan option selected by the user. A first plan option of the one or more plan options is based on a first plan template, and wherein a transfer schedule determined based on the first plan template indicates that the specific amount of resources to be moved from the first user account to the second user account is to increase according to a predetermined increment for each of the one or more predetermined time intervals. A second plan option of the one or more plan options is based on a second plan template, and wherein a transfer schedule determined based on the second plan template indicates that the one or more specific amount of resources to be moved from the first user account to the second user account is to be at a fixed value for each of the one or more predetermined time intervals. A third plan option of the one or more plan options is based on a third plan template, wherein a transfer schedule determined based on the third plan template indicates that the specific amount of resources to be moved from the first user account to the second user account is to increase according to first rate for each of the one or more predetermined time intervals until the objective is fulfilled, and to be increased according to a second rate for each of the one or more predetermined time intervals after the objective is fulfilled. The machine learning model is at least one of a long short-term memory (LSTM) model that is incorporated with a hidden Markov Model (HMM).

The present disclosure, in another aspect, features a computerized method for generating a plan to automatically fulfill a goal associated with a user, the method comprising: receiving instructions, from the user, to generate a recommended plan based on an objective that is fulfilled after completion of one or more conditions, wherein the one or more conditions include a goal value and a target date of fulfilling the objective; retrieving user data from one or more databases; generating, via a machine learning model, one or more plan options based on the user data and one or more plan templates, wherein each plan option is associated with a transfer schedule that indicates one or more specific amount of resources to be transferred from a first user account to a second user account at one or more predetermined time intervals until the goal value is completed by the target date; determining, via the machine learning model, a confidence score for each plan option based on the user data and the associated transfer schedule, wherein the confidence score is associated with a probability that the user is capable of fulfilling the objective by adhering to the transfer schedule in the plan option; implementing the recommended plan by moving resources from the first user account to the second user account according to the transfer schedule associated with the recommended plan until the objective is fulfilled, wherein the recommended plan is the plan option having the highest confidence score among the one or more plan options; and displaying planning graphics associated with the recommended plan, wherein the planning graphics includes a chart indicating a predicted total amount of resources accumulated in the second user account for each of the one or more predetermined time intervals and the one or more specific amount of resources that are predicted to be transferred to the second user account for each of the one or more predetermined time intervals.

The chart of the planning graphics is at least one of a line graph, pie chart, table, scatter plot, histogram, area chart, Gannt chart, column chart, bullet graph, and box plot. The one or more user databases includes a user information database that stores user information that is associated with the user. The user information stored in the user information database includes at least one of one or more other objectives that are associated with the user, and one or more routines that are associated with the user. The one or more user databases includes a user account database that stores one or more user accounts that are associated with the user, wherein each user account includes user data associated with the user. The user account data includes transactions performed with respect to the user accounts, which includes at least one of deposits, withdrawals, purchases, utility bill payments, subscription payments, loan payments, and credit card payments.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for improving accuracy of plans for allocation of resources.

FIG. 2 is a flow diagram of a computerized method for determining recommendation plan.

FIGS. 3A-3H are example diagrams of user interfaces presented to user when determining a recommended plan that is customized for the user.

FIG. 4 is a flow diagram of a computerized method for determining updated recommendation plan.

FIGS. 5A-5B are example diagrams of user interfaces presented to a user when evaluating current recommended plan to determine whether to modify a current recommended plan or generate a new recommended plan.

FIG. 6 is a diagram of an illustrative computing system.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools are discussed herein to facilitate the invention(s) disclosed herein. It should be appreciated by those skilled in the art that any one or more of such tools may be embedded in the application and/or in any of various other ways, and thus while various examples are discussed herein, the inventive aspects of this disclosure are not limited to such examples described herein.

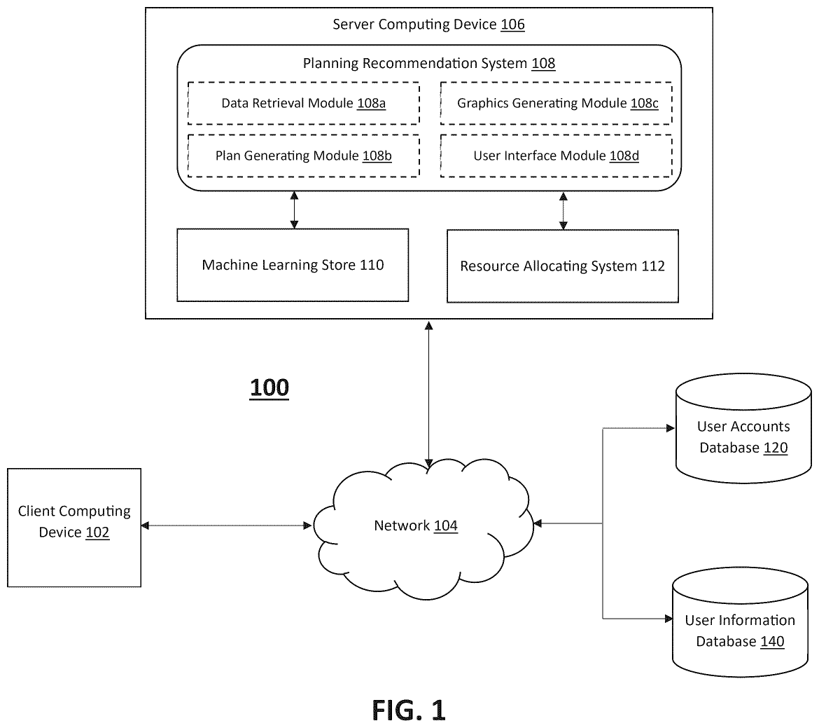

FIG. 1 is a block diagram of a system for 100, which includes a client computing device 102, a server computing device 106, a user accounts database 120, and a user information database 140, all of which are capable of communicating with each other via a communication network 104.

The client computing device 102 can be coupled to a display device (not shown), such as a monitor, display panel, or screen. For example, client computing device 102 can provide a graphical user interface (GUI) via the display device to a user of corresponding device that presents output resulting from the methods and systems described herein and receives input from the user for further processing. Further, the client computing device 102, may include one or more applications that provide additional functionality to the client computing device 102. For example, the client computing device 102 may include a browser application that allows access to the services provided by devices on system 100, via a website, which can be reached by entering a uniform resource locator (URL). Exemplary client computing device 102 include but is not limited to desktop computers, laptop computers, tablets, mobile devices, smartphones, smart watches, Internet-of-Things (IoT) devices, and internet appliances. It should be appreciated that other types of client computing devices that are capable of connecting to components of the system 100 can be used without departing from the scope of invention. Although FIG. 1 depicts a single client computing device 102, it should be appreciated that system 100 can include any number of client computing devices 102.

The communication network 104 can be a local area network, a wide area network, a cellular network, or any type of network such as an intranet, an extranet (for example, to provide controlled access to external users, for example through the Internet), a private or public cloud network, the Internet, etc., or a combination thereof. In addition, the communication network 104 preferably uses TCP/IP (Transmission Control Protocol/Internet Protocol), but other protocols such as SNMP (Simple Network Management Protocol) and HTTP (Hypertext Transfer Protocol) can also be used. In some embodiments, the communication network 104 is comprised of several discrete networks and/or sub-networks (e.g., cellular to Internet).

The server computing device 106 is a device including specialized hardware and/or software modules that execute on a processor and interact with memory modules of the server computing device 106, to transmit data to other components of the system 106, and to receive data from other components of the system 100, as described herein. The server computing device 106 includes several systems, frameworks, stores, and computing modules that execute on one or more processors of the server computing device 106. For example, the server computing device 106 includes a planning recommendation system 108, the machine learning store 110 (which can store all types of machine learning models, such as classification type machine learning model(s), regression type machine learning model(s), support vector machines (SVM) machine learning model(s), ensemble method machine learning model(s), neural network model(s), recurrent neural networks (e.g., long short term memory), deep learning model(s), or (large) language model(s)), and a resource allocating system 112.

The planning recommendation system 108 includes a data retrieval module 108a, a plan generating module 108b, a graphics generating module 108c, and a user interface module 108d. In some embodiments, the data retrieval module 108a, the plan generating module 108b, the graphics generating module 108c, the user interface module 108d, the machine learning store 110, and the resource allocating system 112 are specialized sets of computer software instructions programmed onto one or more dedicated processors in server computing device 106 and can include specifically-designated memory locations and/or registers for executing the specialized computer software instructions.

Although the data retrieval module 108a, the plan generating module 108b, the graphics generating module 108c, the user interface module 108d, the machine learning store 110, and a resource allocating system 112 are shown in FIG. 1 as executing within the same server computing device 106, in some embodiments the functionality of the data retrieval module 108a, the plan generating module 108b, the graphics generating module 108c, the user interface module 108d, the machine learning store 110, and a resource allocating system 112 can be distributed among a plurality of server computing devices. As shown in FIG. 1, the server computing device 106 allows the data retrieval module 108a, the plan generating module 108b, the graphics generating module 108c, the user interface module 108d, the machine learning store 110, and a resource allocating system 112 to communicate with each other in order to exchange data for the purpose of performing the described functions.

It should be appreciated that any number of computing devices, arranged in a variety of architectures, resources, and configurations (e.g., cluster computing, visual computing, cloud computing) can be used without departing from the scope of the invention. Exemplary functionality of the data retrieval module 108a, the plan generating module 108b, the graphics generating module 108c, the user interface module 108d, the machine learning store 110, and a resource allocating system 112 are described in detail below.

The user accounts database 120 is a computing device (or, in some embodiments, may be a set of computing devices) that is configured to provide, receive and store various types of data associated with one or more user accounts. For example, the one or more user accounts database 120 may each be associated with an individual account at a financial institution. Each individual account may be associated with one or more types of transactions accounts (e.g., checking, savings, credit card, etc.). As such, the user accounts database 120 may include data corresponding to transactions that the user has performed with respect to his or her account (e.g., purchase, deposits, transfers of money, payment of bills, uses of credit cards, payment of loans or credit cards, etc.). In other words, the user accounts database 120 may include a historical record of the transactions that the user has performed.

The user information database 140 may include user data related to the user. For example, user information (stored in the user information database 140) may include objectives (or goals) that are associated with the user (e.g., goal to buy new car, or objective to pay off home mortgage). In another example, the user information may include information regarding (purchase) routines of the user (e.g., user purchases espresso at 8:00 am every day from the same café, user performs laundry at least once a week at a commercial laundromat, etc.). The routines may be determined based on the same or similar actions that the user performs at a specific frequency over a predetermined time period.

### Example Routine for Determining a Recommended Plan

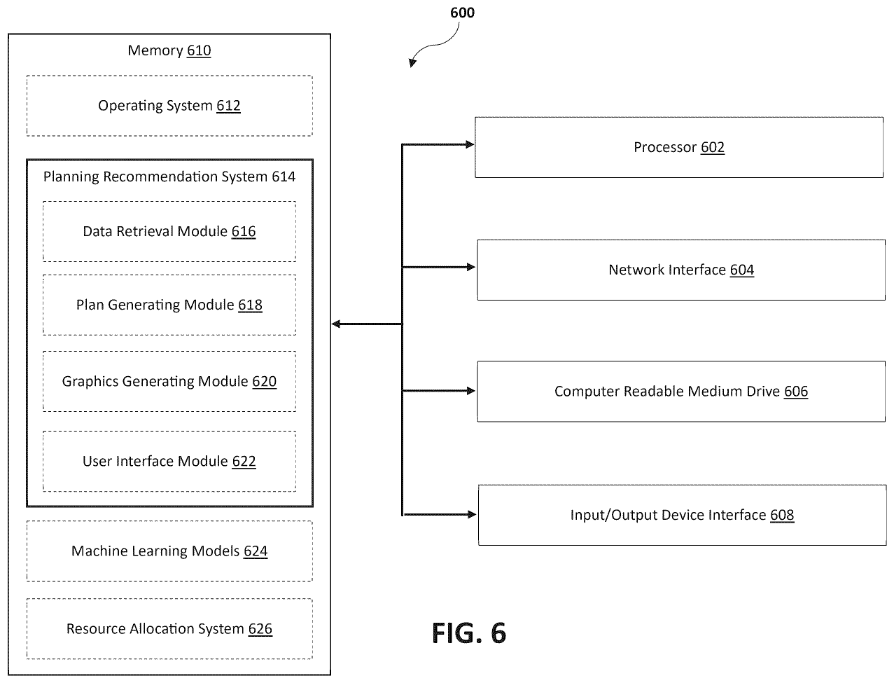

When a routine described herein (i.e., 200, 400, 500) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 600 shown in FIG. 6, and executed by one or more processors. In some embodiments, the routine 200, 400, 500, or portions thereof may be implemented on multiple processors, serially or in parallel.

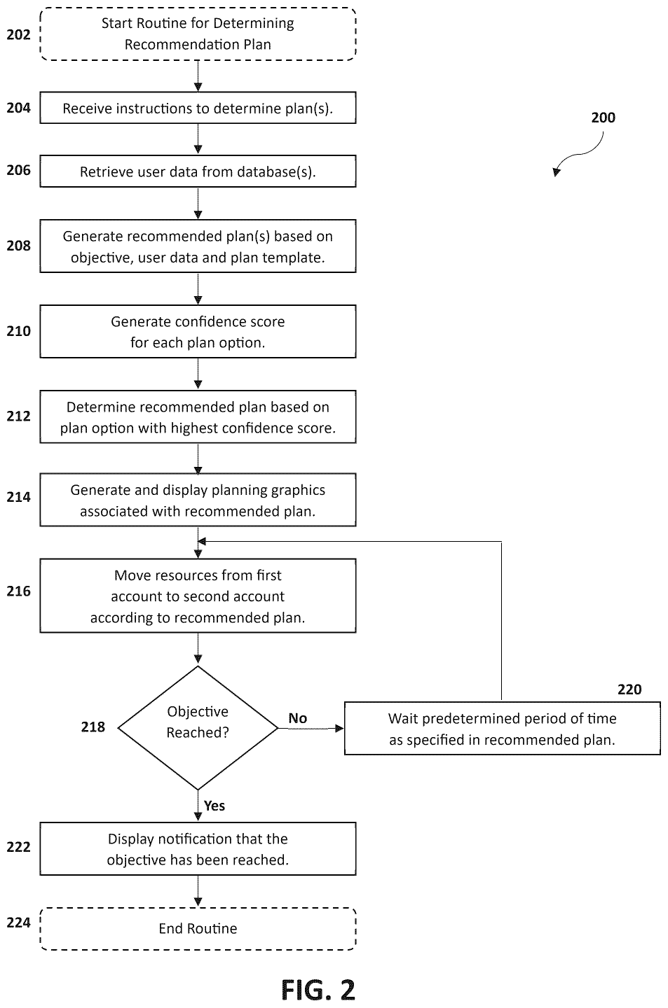

FIG. 2 illustrates example routine 200 (beginning at block 202) for determining a recommended plan, that is performed, for example, by the planning recommendation system 108. At block 302, the planning recommendation system 108 receives instructions to determine a recommended plan to achieve an objective (or goal) associated with the user. The recommended plan may be a predetermined plan that may determine one or more actions to perform to complete one or more conditions associated with the objective (or goal), in which the completion of the one or more conditions may result in attaining the objective (or goal).

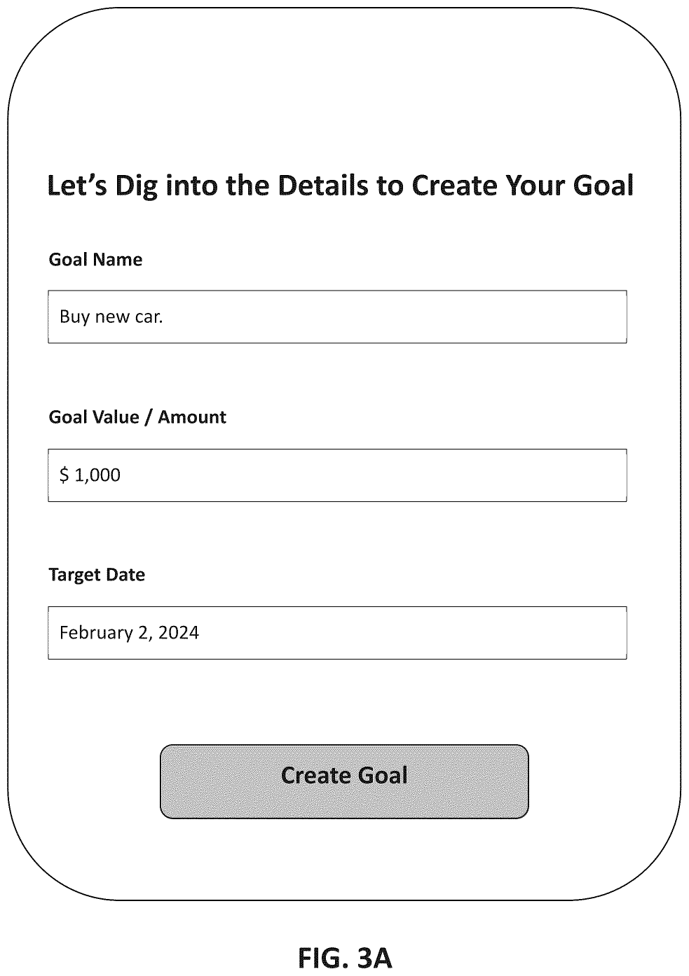

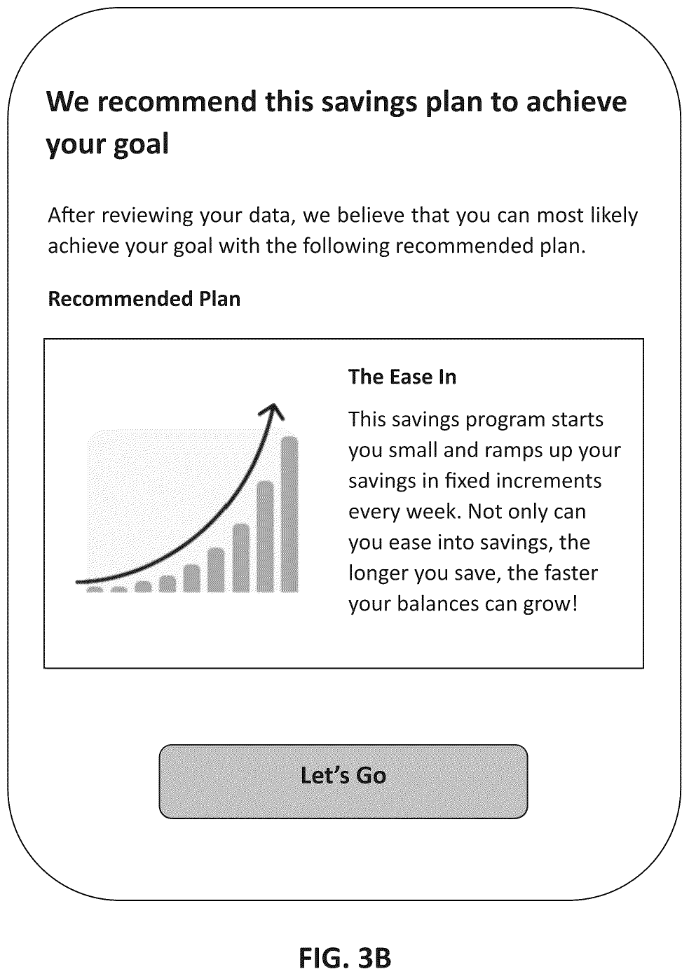

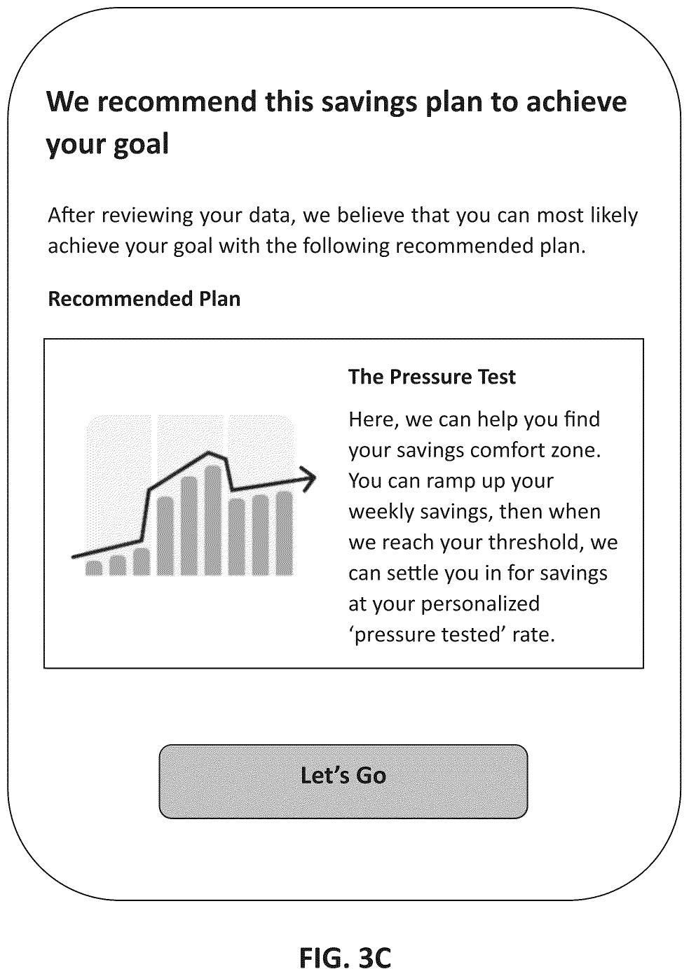

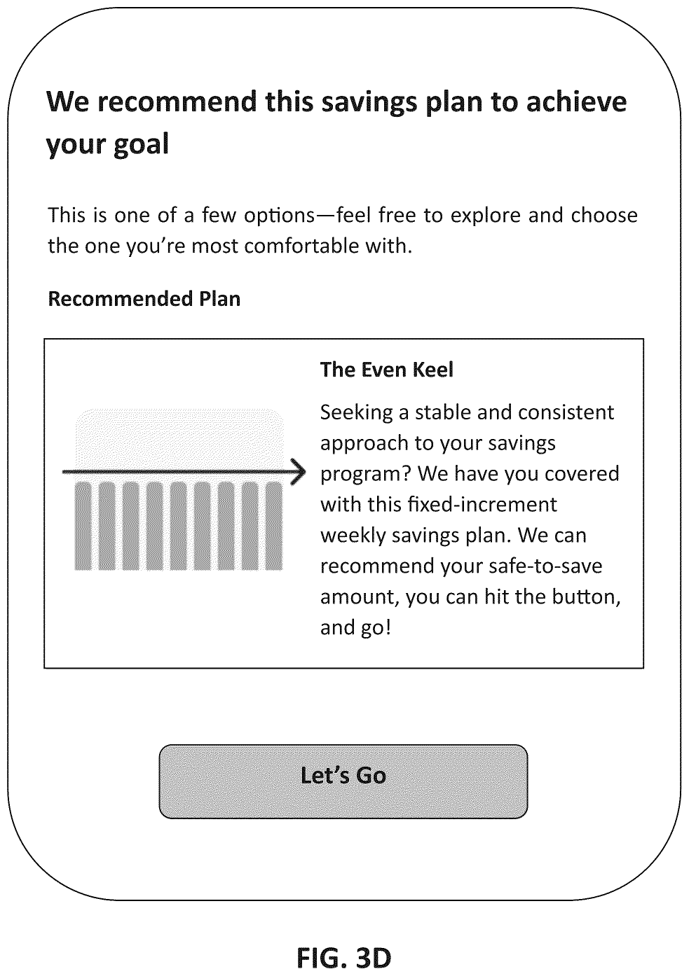

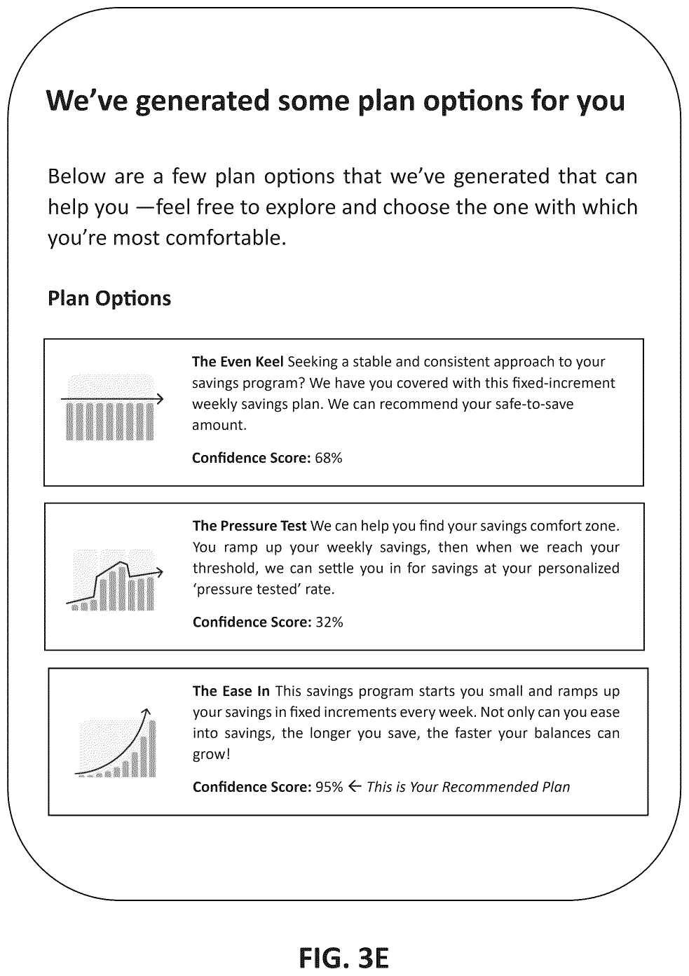

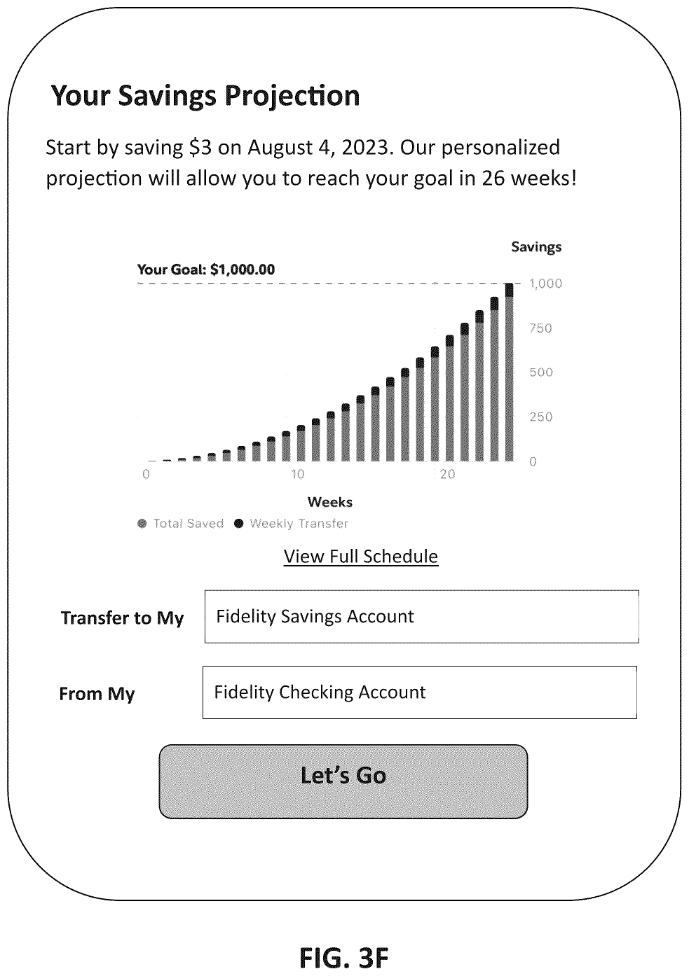

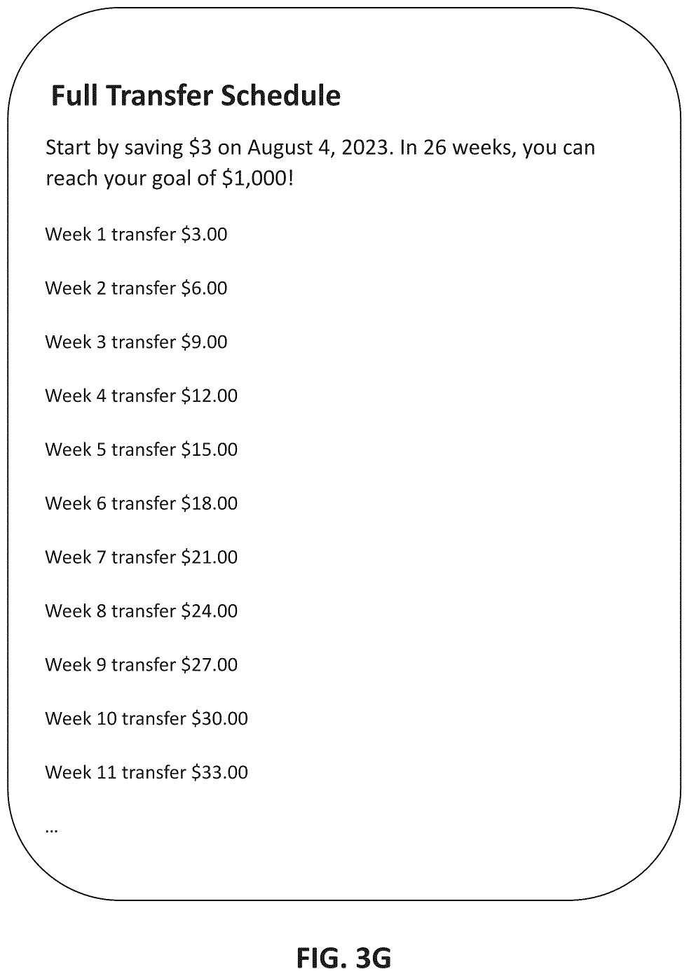

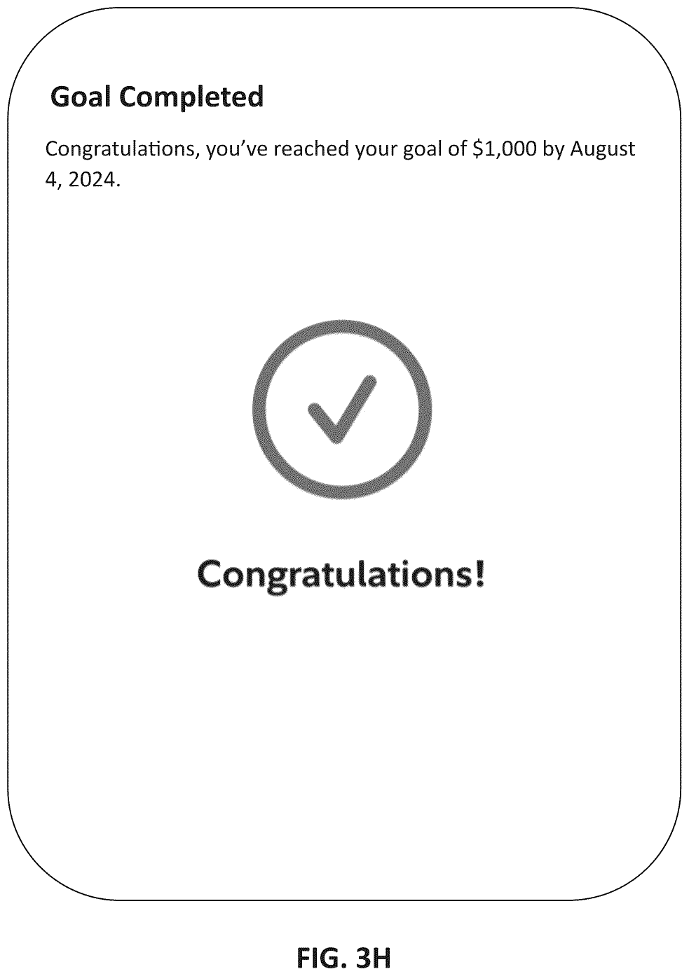

For example, as illustrated in FIG. 3A, a user (e.g., of the client computing device 102) may have an objective or goal (e.g., “Trip to Grand Canyon”), which may be attainable based on the fulfillment of one or more conditions. One example of a condition that is associated with the objective is a goal value (e.g., $1,000), which may be the total number of resources (e.g., currency, securities, gold, silver, etc.) that would allow completion of the objective. Another example of a condition that is associated with the objective is a target date (e.g., “Feb. 2, 2024”), which may be a particular point in time that specifies when the objective is to be completed. It should be noted that the conditions for completing the objective are not limited to the aforementioned examples.

The recommended plan may indicate a process that determines the amount of resources to move from one account of the user to another account of the user (in predetermined time intervals) until the objective or goal is reached. For example, the objective may be associated with a monetary value, and the recommended plan determines how much money (which may be an amount less than the monetary value) to set aside for one or more time intervals until the objective is reached (e.g., when the total amount of money set aside is greater than or equal to the monetary value associated with the objective).

In another example, the user may have a first user account (e.g., banking account) that stores resources (e.g., money) belonging to the user. The user may also have a second user account (e.g., banking account) that stores resources (e.g., money) belonging to the user. In some embodiments, the first user account may be a checking account and the second user account may be a savings account. In other embodiments, the first user account and the second user account may be managed by the same organization. In further embodiments, the first user account and the second user account may be managed by different organizations. In other embodiments, the first user account may be the account from which the user receives income (e.g., salary, business or investment income, etc.). As such, a recommendation plan may be a process that determines how much resources to move from the first user account to the second user account.

At block 206, the data retrieval module 108a of the planning recommendation system 108 may retrieve user data from one or more databases. More specifically, the data retrieval module 108a may connect with one or more databases. For example, as shown in FIG. 1, the data retrieval module 108a may connect with the user accounts database 120 and the user information database 140 via the network 104.

The user accounts database may include one or more user accounts that each correspond to a user. For example, a first user accounts database 120 may be associated with a first entity (e.g., bank, financial institution, commercial organization, etc.). More specifically, the first user account database 120 may include user account data (e.g., amount of money in checking or savings account, transactions performed, existing loans, deposits or withdrawals performed, existing credit cards, etc.) for each user (e.g., customer) managed by the first entity. Likewise, a second user accounts database 120 may be associated with a second entity (e.g., bank, financial institution, commercial organization, etc.), in which the second user accounts database 120 may also contain similar or different user account data (e.g., amount of money in checking or savings account, transactions performed, existing loans, deposits or withdrawals performed, existing credit cards, etc.) from the first user accounts database 120.

The user information database 140 may include user data related to the user. For example, user information (stored in the user information database 140) may include other objectives (or goals) that are associated with the user (e.g., goal to buy new car, or objective to pay off home mortgage). As such, the plan generating module 108b may account for the other goals when determining the recommended plan. In another example, the user information may include information regarding (purchase) routines of the user (e.g., user purchases espresso at 8:00 am every day from the same café, user performs laundry at least once a week at a commercial laundromat, etc.). The routines may be determined based on the same or similar actions that the user performs at a specific frequency over a predetermined time period.

At block 208, the plan generating module 108b generates one or more plan options based on the objective, the user data and one or more plan templates. As discussed previously, the objective may include the goal value and one or more conditions associated with the objective. The user data may be data that is stored in one or more databases associated with the user (e.g., user accounts database 120, user information database 140). The plan template or plan type may be a template from which to generate a plan option. Each plan template may be tailored or customized to the user by the plan generating module 108b using the user data. In other words, the circumstances (e.g., routine, income, expenses, loans, job type, etc.) for each user may be different from each other. More specifically, as described in more detail below, the plan generating module 108b may determine the specific initial (or starting) amount of resources to be transferred from the first user account to the second user account (which may be different from user to user).

Likewise, the plan generating module 108b may also determine a transfer schedule, which schedules the transfer of a specific amount of resources from the first user account to the second user account in predetermined time intervals until the goal value (or goal amount) or objective is reached (which also may be different from user to user). In short, each plan template may be further modified to account for the circumstances of the user. Consequently, a plan option for a first user (that is generated based on a particular template) may be different from a plan option for a second user (that is generated based on the same particular template). In some embodiments, a plan option is generated for each plan template accessible by the planning recommendation system 108.

FIG. 3B illustrates an example of a first plan type (e.g., “The Ease In”) that may be accessible by the plan generating module 108b. In such plan type, a transfer schedule may cause a specific amount of resources (e.g., money) is transferred from a first user account to the second user account in increased increments. Gradually over a predetermined time interval (e.g., daily, weekly, monthly), the amount of resources transferred increases (e.g., week 1: $1.00, week 2: $2.00, week 3: $4.00, week 4: $8.00, etc.) according to an increment. In some embodiments, the increment is determined by the following equation:

$$i = \frac{2 s - 2 na}{{n}^{2} - n} \qquad ( 1 )$$

where i is the increment, s is the current amount of accumulated resources (e.g., the amount of resources currently in the second user account), n is the current total number of transfers (e.g., number of times a transferred has been performed between the first user account to the second user account), and a is the starting amount (e.g., the initial amount transferred from the first user account to the second user account).

FIG. 3C illustrates an example of a second plan type (e.g., “The Pressure Test”) that may be accessible by the plan generating module 108b. In such plan type, a transfer schedule may cause a specific amount of resources (e.g., money) to be transferred from a first user account to the second user account. Gradually over a predetermined time interval (e.g., daily, weekly, monthly), the amount of resources transferred increases at a first rate or increment (e.g., week 1: $1.00, week 2: $2.00, week 3: $4.00, week 4: $8.00, etc.) until a predetermined threshold is reached. After the predetermined threshold is reached, the amount of resources is transferred at a second rate or increment, which may be lower than the first rate (e.g., e.g., week 15: $1.00, week 16: $2.00, week 17: $3.00, week 18: $4.00, etc.). In some embodiments, the first rate or the second rate may be determined using equation (1). For example, the first rate may be an exponential rate, and the second rate may be a linear rate. In another example, the first rate may be an exponential rate (or linear rate), and the second rate may be a constant rate.

In some embodiments, the plan generating module 108b determines at least one of the predetermined threshold, the first rate, and the second rate. In other embodiments, the user determines at least one of the predetermined threshold, the first rate, and the second rate. In some embodiments, the predetermined threshold is the value at which the amount of accumulated resources (accumulated according to the first rate) reaches a value less than the goal value (e.g., a quarter, half, or three quarters of the goal value). In other embodiments, the predetermined threshold may be equivalent to the goal value, in which resources continue to be transferred even after the objective or goal value has been reached. In other words, when the amount of resources (accumulated according to the first rate) reaches the goal value (e.g., reaches the predetermined threshold) and/or all of the conditions associated with the objective have been met or completed, the resources continue to be transferred to the second user account but at a second rate (instead of the first rate) until, for example, the user stops such transfer.

FIG. 3D illustrates an example of a third plan type (e.g., “The Even Keel”) that may be accessible by the plan generating module 108b. In such plan type, a transfer schedule may cause a specific amount of resources (e.g., money) is transferred from a first user account to the second user account in fixed-increments. In other words, gradually over a predetermined time interval (e.g., daily, weekly, monthly), the amount of resources transferred remains the same (e.g., week 1: $1.00, week 2: $1.00, week 3: $1.00, week 4: $1.00, etc.).

To generate the one or more plan options, the plan generating module 108b may utilize a machine learning model that is stored by the machine learning store 110. For example, the machine learning model may be a long short-term memory (LSTM) machine learning model that is a type of recurrent neural network (RNN) that is capable of learning long-term dependencies in sequential data. Such capability is possible due to the fact that the LSTM model solves the vanishing gradient problem, in which information from a previous point in time is lost as the traditional RNN processes information.

More specifically, the LSTM includes a memory cell and a gating mechanism. The memory cell stores information for a predetermined period of time, thereby allowing the LSTM model to remember past data. The gating mechanism regulates the flow of information into and out of the memory cell. The gating mechanism includes an input gate, an output gate, and a forget gate. The input gate determines which new information should be stored in the memory cell. The output gate determines which information from the memory cell is to be outputted. The forget gate determines which information should be forgotten or removed from the memory cell. Due to such configuration, LSTM models capable of performing tasks related to time series forecasting. Time series forecasting is when predictions are made based on historical time stamped data, which is data that is associated with a specific instance of time. For example, time stamped data may include historical transactions made by the user (e.g., purchases, sales, bill payments, subscription payments, deposits, withdrawals, loan payments, etc.).

In another example, the machine learning model or LSTM model may incorporate a hidden Markov Model (HMM). Such combination may be effective because the HMM may efficiently model the probabilistic states of financial health or confidence score (explained infra), while the LSTM model provides predictive power. The HMM is a statistical model that is used to describe the probabilistic relationship between a sequence of observations and a sequence of hidden states. The hidden states are the underlying variables that generate the observed data, but may not be directly observable. The observations are the variables that are measured and observed. The relationship between the hidden states and the observations is modeled using a probability distribution. As such, the HMM shows the relationship between the hidden states and the observations using two sets of probabilities: the transition probabilities and the emission probabilities. The transition probabilities describe the probability of transitioning from one hidden state to another. The emission probabilities describe the probability of observing an output given a hidden state.

A machine learning model (or an LSTM) incorporating the HMM model may be trained by first determining a state space (e.g., set of all possible hidden states) and an observation space (is the set of all possible observations), an initial state distribution (e.g., probability distribution over the initial state), the state transition probabilities (e.g., a transition matrix describing the probabilities of transitioning from one state to another), the observation likelihoods (e.g., an emission matrix describing probabilities of generating each observation from each state). Next, the machine learning model (or an LSTM) is trained by, for example, estimating parameters of the state transition probabilities and the observation likelihoods using the Baum-Welch algorithm (e.g., an algorithm for determining the optimal transition matrix and emission matrix of an HMM given a set of observations), or the forward-backward algorithm (e.g., which computes the likelihood of a set of observations given an optimized HMM of the situation being analyzed). This may be facilitated by iteratively updating the parameters until convergence. With respect to inference time, the Viterbi algorithm may be used to compute the most likely sequence of hidden states. This can be used to predict future observations, classify sequences, or detect patterns in sequential data.

In yet another example, the machine learning model or LSTM model may incorporate the hidden Markov Model (HMM) using an End-to-End Joint Model (e.g., output data (e.g., plan option(s), confidence score(s)) from the model is generated from raw input data (e.g., unmodified user data) without any extra processing steps such as feature extraction, data preprocessing, or feature engineering being performed on the input data). In other words, using the End-to-End Joint Model generates an integrated model or approach that combines the HMM with the LSTM model into a single framework. In some embodiments, the components of the HMM and the LSTM model in the integrated model operate in parallel.

With this architecture, the LSTM receives the input data (which may be in sequence) and processes the sequential input data to generate a sequence of hidden states (that describe the underlying structure and context of the data). The hidden states of the HMM are guided by memory cells of the LSTM (e.g., the hidden states of the HMM are interpreted as the hidden states of the LSTM). In some embodiments, the LSTM may output sequences of hidden states with probability distributions to the HMM outputs. Then, the HMM can influence the gating mechanisms of the LSTM (e.g., thereby affecting the output of the LSTM). In other embodiments, the transition probabilities and the emission probabilities of the HMM are determined based on the hidden states of the HMM (which were guided by the memory cells or hidden states of the LSTM). The HMM can use such determined transition probabilities and the emission probabilities to generate additional output during inference time (or, in the case of training the LSTM, guide the training process of the LSTM). As such, the final output (e.g., plan option(s), confidence score(s)) may be generated based on the output of the LSTM model, the output of the HMM, or a combination of both.

This approach (e.g., using the integrated model) is different from the conventional approach as it combines probabilistic reasoning (e.g., HMM) within a learned, adaptive neural framework (e.g., LSTM) allowing a richer representation of sequential structure. Further, there is an improved performance in the integrated model. Since, the LSTM can capture patterns and trends in time series data and the HMM can model underlying states or hidden variables (which allows the model to understand better the relationship between data), such combination can improve the accuracy of forecasting. In addition, the integrated model can provide more protection against noise and variations in data. Moreover, the integrated model can also generalize better to new data.

Because the one or more embodiments as described herein improve the accuracy of forecasting when compared to conventional systems and techniques, the one or more embodiments as described herein provide an improvement in the existing technology field of time series forecasting. Further, the one or more embodiments as described herein are more when compared to conventional systems and techniques, provide more resilience to variations of data and noise. Accordingly, the one or more embodiments as described herein are integrated into the practical application of determining a recommended plan based on accurate forecasting

In some embodiments, the integrated model (e.g., LSTM model incorporating HMM using an End-to-End Joint Model) is trained jointly, by using a combination of Expectation-Maximization (for the HMM) and Backpropagation Through Time (for LSTM). The objective is to determine the parameters that maximize the likelihood of the observed sequence data. The Backpropagation Through Time is a process for training recurrent neural networks (e.g., LSTM models). Expectation-Maximum (EM) may be an algorithm that determines maximum likelihood estimates of parameters in probabilistic models (e.g., HMM), in which the model includes latent (e.g., hidden) variables. More specifically, the EM algorithm may be used to estimate model parameters (e.g., transition probabilities, emission probabilities, initial state probabilities) for the HMM, given a sequence of observations. As such, the EM algorithm is important because it provides a process for determining the parameters of the HMM. This is especially useful in cases in which the latent (e.g., hidden) variables are difficult to observe directly.

At block 210, the plan generating module 108b generates a confidence score for each of the generated plan options. A confidence score may determine the probability that the user can complete the objective or goal using such plan option. In other words, each of the generated plan options (e.g., generated in block 208) may be associated with a confidence score. The confidence score may be a value (e.g., numeric) that is determined based on user data. For example, the confidence score may be generated by the machine learning model or LSTM model (e.g., incorporated using HMM) using the user data. For example, the confidence score may be expressed in a percentage form that indicates the probability that the user can complete the objective or goal using such plan option.

At block 212, the plan generating module 108b determines the recommended plan based on the plan option with the highest confidence score. As discussed previously, the one or more recommended plans may each be assigned a confidence score, in which the confidence score may be a value (e.g., numeric unit) that allows each of the plan options to be ordered or sequenced. For example, the confidence score may be arranged in an order from numerically largest confidence score to numerically lowest confidence score. In another example, the confidence score may represent a probability predicted by the plan generating module 108b that the objective may be reached by following the recommended plan.

As such, the plan generating module 108b may select the plan option with the numerically largest or highest confidence score. In some embodiments, the plan generating module 108b automatically selects and implements the plan option having the highest confidence score. In other embodiments, the plan generating module 108b may transmit each of the one or more plan options (along with their corresponding confidence scores) to the user interface module 108b, which causes the one or more plan options (with confidence scores) to be displayed, for example, on the client computer 102 of the user, as shown in FIG. 3E. As shown in FIG. 3E, the user is presented with multiple generated plan options (e.g., “The Even Keel”, “The Pressure Test”, “The Ease In”) with corresponding descriptions to provide the user with a general view of the associated plan option. In addition, each plan option is also associated with a confidence score (e.g., “The Even Keel: 68%”, “The Pressure Test: 32%”, “The Ease In: 95%”). Further, the plan generating module 108b also displays a message (“This is Your Recommended Plan”) to the user indicating which of the plan options is recommended by the plan generating module 108b to be the recommended plan for the user to select (e.g., the plan option with the highest confidence score). Regardless, the user may select any of the plan options presented to the user.

At block 214, the graphics generating module 108c generates and displays planning graphics associated with the recommended plan. After the plan generating module 108b has determined the recommended plan (or the user has selected a plan option as the recommended plan), the plan generating module 108b may transmit the recommended plan to the graphics generating module 108c, which generates planning graphics associated with the recommended plan. FIG. 3F shows an example of a planning graphics, which includes a chart displaying the steps for moving resources from a first user account (e.g., “Fidelity Checking Account”) to a second user account (e.g., “Fidelity Savings Account”). More specifically, the chart displays the (predicted) accumulated total amount of resources saved (“Total Saved”) in the second user account for each predetermined time interval (e.g., “weeks” in FIG. 3F) along with a specific amount of resource transferred (“Weekly Transfer”) to the second user account for each of the predetermined time interval. It should be noted that the user can allow the resource allocation module 112 to access one or more user accounts associated with the user. Further, the user may select (e.g., on the user interface associated with FIG. 3F) user accounts that are managed by different entities (e.g., financial organizations).

It should also be noted that the chart displayed on the user interface shown in FIG. 3F is in the form of a bar graph. However, it should be noted that the graph may be in other forms as well (e.g., line graph, pie chart, table, scatter plot, histogram, area chart, Gannt chart, column chart, bullet graph, box plot, etc.). In some embodiments, the user may view the chart displayed in FIG. 3F over the course of the time period between the commencement of the recommended plan to the completion of the objective associated with the recommended plan. In such case, the planning graphics generating module 108c may update the chart. For example, the actual accumulated total amount of resources (e.g., accumulated total amount of resources that are currently present in the second user account) may be in a first color, while the (predicted) accumulated total amount of resources (e.g., accumulated total amount of resources that have are not present in the second user account, but are to be predicted to be in the future) may be in a second color different from a first color. Likewise, the actual amount of resources transferred (e.g., “the specific amount of resources that have actually been transferred”) may be in a third color (different from the first color and second color), while the predicted amount of resources transferred (e.g., “the specific amount of resources that are not yet transferred”) to the second user account, but are intended to be transferred in the future according to the transfer schedule”) may be in a fourth color different from the first color, the second color, and the third color. As such, each of the bars in the bar graph shown in FIG. 3F may change colors accordingly.

As shown in FIG. 3G, the planning graphics may also include a transfer schedule that is generated for display on a user interface before the user. As shown, the user interface in FIG. 3G includes the goal value (e.g., “$1,000.00”), the starting date (e.g., “Aug. 4, 2023”), the initial amount transferred form the first user account to the second user account (e.g., “$3”), the time period (e.g., total number of weeks) to reach the goal value (e.g., “26 weeks”), the total amount of accumulated resources for each point (e.g., week) in the time period (e.g., “Total Saved”), and the frequency of the amount of resources transferred for each point (e.g., week) in time (e.g., “Weekly Transfer”), and the rate or increment for performing the transfer (e.g., “$3”). It should be noted that the planning graphics may be different for each objective, different for each plan option generated by the plan generating module 108b, and different for each user as well. In other words, the planning graphics are associated with the recommended plan which may be unique due to being based on the objective, user data, and plan type.

At block 216, the resource allocation system 112 moves resources from a first user account to a second user account according to the recommended plan. More specifically, the resource allocation module 112 may repeatedly move a specific amount of resources (e.g., less than the goal value) according to a frequency or time interval (e.g., second, minute, hour, day, week, month, year, etc.). specified in the recommended plan (e.g., transfer schedule). For example, as shown in FIG. 3G, an example of a transfer schedule is displayed on the user interface for the user to view. The transfer schedule indicates a transferred amount (e.g., “$3”, “$6”, “$9”, etc.) for each unit of time (e.g., “Week 1”, “Week 2”, “Week 3”, etc.). In the example shown in FIG. 3G, the transferred amount increases with every week, thereby allowing the total amount transferred to accumulate quickly.

It should be noted that the transfer is performed automatically by the resource allocation system 112. In other words, the user may select a first user account and a second user account to perform the transfer. More specifically, as shown by the example in FIG. 3F, the user can select the first user account (“Fidelity Checking Account”) from which to transfer or draw resources. Likewise, the user can also select a second user account (“Fidelity Savings Account”) as a target of the transfer (e.g., transfer resources from the first user account to the second user account). It should be noted that the user can select user accounts that are associated with the same financial institution (e.g., Fidelity Investments). Likewise, the user can also select user accounts associated with different financial institutions (e.g., first user account is associated with Washington Mutual, Inc., while the second user account is associated with Fidelity Investments).

At block 218, a determination is made on whether the objective has been reached. For example, the resource allocation system 112 may determine that the objective may be reached when one or more conditions associated with the goal are completed. An example (of a condition being completed) would be the accumulated amount of resources transferred being greater or equal to the goal value. Another example of a condition being completed, would be the completion of the goal by the target date. In the case that the objective has not been reached (block 218, no), the routine moves to block 220.

At block 220, the resource allocation system 112 waits a predetermined period of time as specified in the recommended plan. For example, the resource allocation system 112 may determine at block 218, that the objective has not been met because the accumulated transfers have not reached the goal value. As such, the resource allocation system 112 waits a predetermined period of time (e.g., second, minute, hour, day, week, month, year, etc.) until the next transfer is scheduled (e.g., according to the transfer schedule) to occur. For example, as discussed previously with respect to FIG. 3G, the predetermined time period is a week. As such, the resource allocation system 112 may wait a week before performing the action with respect to block 216 (i.e., move resources from first user account to second user account according to recommended plan).

In the case that the objective has been reached (block 218, yes), the routine moves to block 222. For example, the resource allocation system 112 may determine at block 218, that the objective has been met because the accumulated transfers have reached the goal value. As such, the routine moves to block 222. At block 222, the user interface module 108d displays a notification that the objective has been reached. For example, after the objective has been reached, the resource allocation system 112 may transmit instructions or a notification to the user interface module 108d to cause the user interface module 108d to generate a notification (that the objective has been reached) to be displayed before the user (e.g., of the client computing device 102). FIG. 3H shows an example of a user interface displaying the notification. As shown, the notification includes an indication that the goal has been completed (e.g., “Goal Completed”), the goal value (e.g., “$1,000”), and the target date (e.g., “Aug. 4, 2024”). The routine ends at block 224.

### Example Routine for Evaluating Current Recommended Plan

When a routine described herein (i.e., 200 and 400) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 600 shown in FIG. 6, and executed by one or more processors. In some embodiments, the routine 20 and 400, or portions thereof may be implemented on multiple processors, serially or in parallel.

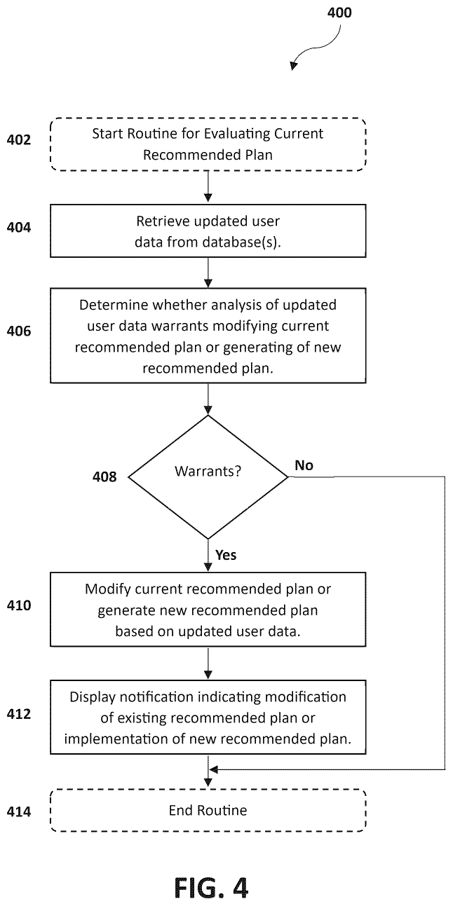

FIG. 4 illustrates example routine 400 (beginning at block 402) for determining an updated recommended plan, that is performed, for example, by the planning recommendation system 108. In some embodiments, the routine 400 may be performed in parallel with the routine 200 of FIG. 2. In other embodiments, the routine 400 may be performed between block 220 of the routine 200 and block 216 of the routine 200. For example, the routine 400 may be performed when block 220 starts to perform the waiting action and before the start of the actions described in block 216. In further embodiments, the routine 400 may be performed in parallel with the (waiting) action in block 220.

At block 402, the data retrieval module 108a retrieves updated user data from database(s). Updated user data may be different from the user data previously obtained in block 206 of the routine 200 in FIG. 2. As discussed previously, the user data may include data from the user accounts database 120, which may be updated continuously by the entity managing the user accounts database 120. For example, a user account managed by the user accounts database 120 may correspond to a bank account (e.g., checking account, savings account, etc.) managed by a financial organization. As such, the user account may frequently include updates, such as new transactions (e.g., purchase, deposits, transfers of money, payment of bills, uses of credit cards, payment of loans or credit cards, etc.).

More specifically, the data retrieval module 108a retrieves updated user data from one or more databases (e.g., user accounts database 120, user information database 140, etc.) at predetermined time intervals (e.g., second, minute, hour, day, week, month, year, etc.). In some embodiments, the predetermined time intervals may be similar to the predetermined time intervals in the transfer schedule, as discussed previously. In other words, after the action described in block 220 (of routine 200 in FIG. 2) begins performance (e.g., begins waiting), the data retrieval module 108a retrieves updated user data from the one or more databases. For example, as discussed previously with respect to the transfer schedule shown in FIG. 3H, the data retrieval module 108a may retrieve the updated user data on a weekly basis.

At block 406, the plan generating module 108b determines whether an analysis of the updated user data warrants modifying the current recommended plan or generating a new recommended plan. The analysis of the updated user data may be performed by the plan generating module 108b using a machine learning model, such as a long short-term memory (LSTM). In some embodiments, the machine learning model or the LSTM model may incorporate features of the hidden Markov Model (HMM). As such, the machine learning model may analyze the updated user data to determine whether the situation or circumstance of the user has changed. Further, the machine learning model also determine whether such change is sufficient to warrant modifying the current recommended plan or generating a new recommended plan.

In one example, the user may have received a raise (e.g., increased salary) at his or her job (e.g., as evidenced by the increased in deposits). As such, it may be possible to modify the current recommended plan to accommodate such update by, for example, increasing the amount of resources to be transferred. For example, with reference to the transfer schedule in FIG. 3H, the “Week 4” transfer is originally “$12.00” under the current recommended plan, but under the modified recommended plan, “Week 4” may be modified to “$27.00”. Such increase may allow the user to more quickly complete the objective. It should also be noted that the target date may be modified to an earlier date to reflect the change as well.

Likewise, in another example, the living costs may have increased due to, for example, inflation. The increase in prices may affect the ability of the user to complete the objective. Such increase may be reflected in the user data (e.g., transactions performed). As such, it may be possible to modify the current recommended plan to accommodate such update by, for example, decreasing the amount of resources to be transferred. For example, with reference to the transfer schedule in FIG. 3H, the “Week 4” transfer was originally “$30.00” under the current recommended plan, but under the modified recommended plan, “Week 4” may be modified to “$8.00”. Such decrease may allow the user to still be able to complete the objective. It should also be noted that, in such example, the target date may be modified to a later date to reflect the change as well.

In a similar example, the user may have received a job promotion, in which the salary of the user is increased by a significant amount. The plan generating module 108b may determine that the user now has a sufficient source of resources to enact a change in the current recommended plan. In other words, the plan generating module 108b may generate a new recommended plan including a new transfer schedule (associated with such recommended plan). For example, the user may have been under the “The Even Keel” recommended plan (e.g., described with respect to FIG. 3D supra). The plan generating module 108b may now determine that the new recommended plan should be “The Ease In” (e.g., described with respect to FIG. 3B supra), in which the new associated transfer schedule (generated according to the “The Ease In” plan type) enables the user to increase the transferred amount at each predetermined time interval, thereby allowing the user to reach the objective faster (e.g., target date changes to an earlier date).

Likewise, in another example, the user may obtain a new job in which the salary is significantly lower than the previous job (e.g., the user wishes to spend more time with the family). The plan generating module 108b may determine that the user now has insufficient source of resources to achieve the objective. Therefore, the plan generating module 108b may enact a change in the current recommended plan. In other words, the plan generating module 108b may generate a new recommended plan including a new transfer schedule (associated with such recommended plan). For example, the user may have been under the “The Pressure Test” recommended plan (e.g., described with respect to FIG. 3C supra). The plan generating module 108b may now determine that the new recommended plan should be “The Even Keel” (e.g., described with respect to FIG. 3D supra), which enables the user to achieve the objective but at a later date (e.g., (e.g., target date changes to a later date).

In the case that the analysis of the updated user data warrants modifying current recommended plan or generating of new recommended plan (block 408, yes), the routine moves to block 410. At block 410, the plan generating module 108b modifies the current recommended plan or generates a new recommended plan based on the updated user data. As discussed previously, the machine learning model or LSTM model (incorporated with HMM) may modify the current recommended plan or generate a new recommended plan. In such case, the machine learning model may receive the user data as input, and output at least one of a new transfer schedule or a new recommended plan. In some embodiments, the machine learning model may generate a new recommended plan after determining that the user is not capable of completing the objective or goal using any transfer schedule developed by the machine learning model in connection with the current recommended plan.

In some embodiments, with respect to generating a new recommended plan, the plan generating module 108b may generate one or more new plan options and assign a new confidence score to each new plan option. The plan generating module 108b determines the new recommended plan based on the new plan option with the highest confidence score. As discussed previously, the one or more new plan options may each be assigned a new confidence score, in which the new confidence score may be a value (e.g., numeric unit) that allows each of the plan options to be ordered or sequenced. As such, the plan generating module 108b may select the new plan option with the numerically largest or highest new confidence score. In some embodiments, the plan generating module 108b automatically selects and implements the new plan option having the highest new confidence score (relative to the other new confidence scores).

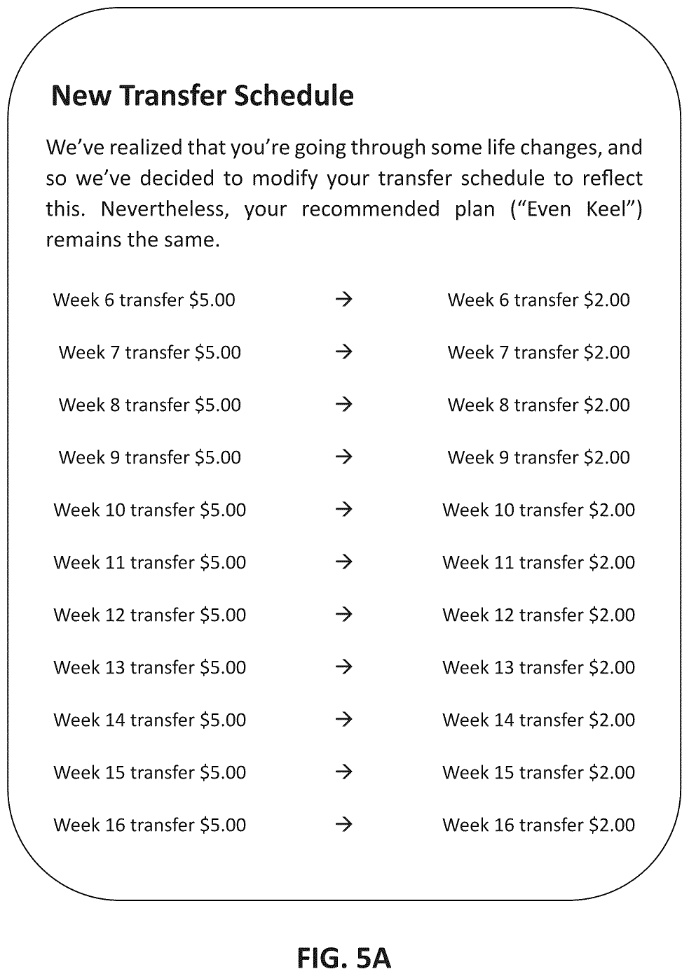

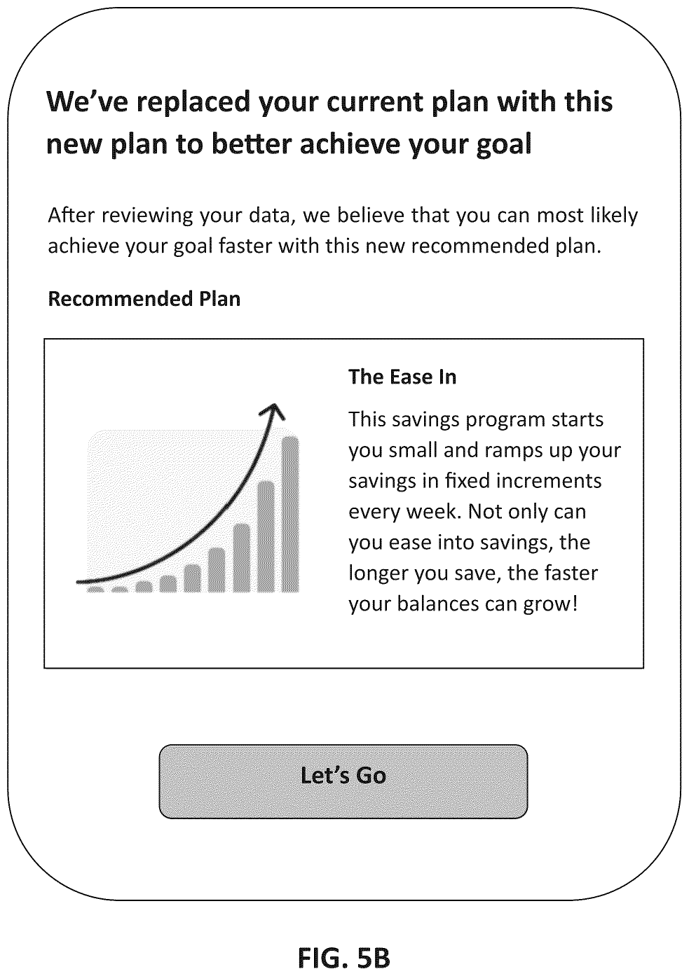

At block 412, the user interface module 108d displays a notification indicating modification of existing recommended plan or implementation of new recommended plan. In some embodiments, the graphics generating module 108c may generate the notification and transmit such notification to the user interface module 108d for display. FIG. 5A shows an example of a user interface that is displayed to the user (e.g., on the client computing device 102), in which the user interface indicates that a new transfer schedule has been provided to the user. As shown, the recommended plan (e.g., “Even Keel”) remains the same, but the weekly transfer has been changed from “$5.00” to “3.00”. FIG. 5B shows an example of a user interface that is displayed to the user (e.g., on the client computing device 102), in which the user interface indicates that the current recommended plan has been replaced with a new recommended plan in order to allow the user to achieve the objective earlier than the target date. In some embodiments, the user interface (e.g., in FIG. 5A and FIG. 5B) is shown to inform the user, and the new recommended plan or the modified recommended plan is automatically implemented without any need for confirmation from the user. The routine ends at block 414.

### Execution Environment

FIG. 6 illustrates various components of an example computing device 600 configured to implement various functionality described herein.

In some embodiments, the computing device 600 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provide by the computing device 600 may be implemented as webs services consumable via one or more communication networks. In further embodiments, the computing device 600 is provided by one or more virtual machines implemented in a hosted computing environment. The hosted computing environment may include one or more rapidly provisioned and released computing resources such as computing devices, networking devices, and/or storage devices. A hosted computing environment may also be referred to as a “cloud” computing environment.

In some embodiments, as shown, a computing device 600 may include one or more processors 602, such as physical central processing units (“CPUs”); one or more network interfaces 604, such as network interface cards (“NICs”); one or more computer readable medium drives 606, such as a high density disk (“HDDs”), solid state drives (“SSDs”), flash drives, and/or other persistent computer readable media; one or more input/output drive interfaces 608; and one or more computer-readable memories 610, such as random access memory (“RAM”) and/or other volatile non-transitory readable media. The one or more computer-readable memories 610 may include computer program instructions that one or more computer processors 602 execute and/or data that the one or more computer processors 602 use in order to implement one or more embodiment. For example, the one or more computer-readable memories 610 can store an operating system 612 to provide general administration of the computing device 600.

As another example, the one or more computer-readable memories 610 can store a planning recommendation system 614 (e.g., planning recommendation system 108) for generating and modifying plans. The planning recommendation system 614 includes a data retrieval module 616 (e.g., data retrieval module 616) for retrieving data from one or more databases, a plan generating module 618 (e.g., plan generating module 108b) for generating one or more plans, a graphics generating module 620 (e.g., graphics generating module 108c) for generating planning graphics associated with a plan, a user interface module 622 (e.g., user interface module 108d) for displaying various user interfaces (e.g., notifications, graphs, etc.).

In yet another example, the one or more computer-readable memories 610 can store machine learning model(s) 624 (e.g., machine learning store 110) that may include machine learning model(s) such as a long short-term memory (LSTM) model that may be incorporated with a hidden Markov Model (HMM). In a further example, the one or more computer-readable memories 610 can store a resource allocation system 626 (e.g., resource allocation system 112) that can move resources from one account to another account.

### Terminology

The term “model,” as used in the present disclosure, can include computer-based models of any type and of any level of complexity, such as any type of sequential, functional, or concurrent model. Models can further include various types of computation models, such as, for example, artificial neural networks (“NN”), language models (e.g., large language models (“LLMs”)), artificial intelligence (“AI”) models, machine learning (“ML”) models, multimodals (e.g., models or combinations of models that can accept inputs of multiple modalities, such as images and text), and/or the like.

While certain aspects and implementations are discussed herein with reference to use of a language model, LLM, and/or AI, those aspects and implementations may be performed by any other language model, LLM, AI model, generative AI model, generative model, ML model, NN, multimodel model, and/or other algorithmic process. Similarly, while certain aspects and implementations are discussed herein with reference to use of a ML model, those aspects and implementations may be performed any other AI model, generative AI model, generative model, NN, multimodel model, and/or other algorithmic processes.

In various implementations, the models of the present disclosure may be locally hosted, cloud managed, accessed via one or more Application Programming Interfaces (“API's”), and/or any combination of the foregoing and/or the like. Additionally, in various implementations, the models of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus (e.g., a programmable processor, a computer, and/or multiple computers). A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry (e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like). Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data (e.g., magnetic, magneto-optical disks, or optical disks). A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices (e.g., DRAM, SRAM, EPROM, EEPROM, and flash memory devices); magnetic disks (e.g., internal hard disks or removable disks); magneto-optical disks; and optical disks (e.g., CD, DVD, HD-DVD, and Blu-ray disks). The processor and the memory can be supplemented by and/or incorporated in special purpose logic circuitry.

To provide for interaction with a user, the above-described techniques can be implemented on a computing device in communication with a display device (e.g., a CRT (cathode ray tube), plasma, or LCD (liquid crystal display) monitor, a mobile device display or screen, a holographic device and/or projector, for displaying information to the user and a keyboard and a pointing device (e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback (e.g., visual feedback, auditory feedback, or tactile feedback; and input from the user can be received in any form, including acoustic, speech, and/or tactile input).

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computing (or computer) system for generating a plan to automatically fulfill a goal associated with a user, the system comprising a server computing device having a memory for storing computer-executable instructions and a processor that executes the computer-executable instructions to:
receive instructions, from the user, to generate a recommended plan based on an objective that is fulfilled after completion of one or more conditions, wherein the one or more conditions include a goal value and a target date of fulfilling the objective;
retrieve user data from one or more databases;
generate, via a machine learning model, one or more plan options based on the user data and one or more plan templates, wherein each plan option is associated with a transfer schedule that indicates one or more specific amount of resources to be transferred from a first user account to a second user account at one or more predetermined time intervals until the goal value is completed by the target date;
determine, via the machine learning model, a confidence score for each plan option based on the user data and the associated transfer schedule, wherein the confidence score is associated with a probability that the user is capable of fulfilling the objective by adhering to the transfer schedule in the plan option;
implement the recommended plan by moving resources from the first user account to the second user account according to the transfer schedule associated with the recommended plan until the objective is fulfilled, wherein the recommended plan is the plan option having the highest confidence score among the one or more plan options; and
display planning graphics associated with the recommended plan, wherein the planning graphics includes a chart indicating a predicted total amount of resources accumulated in the second user account for each of the one or more predetermined time intervals and the one or more specific amount of resources that are predicted to be transferred to the second user account for each of the one or more predetermined time intervals.

2. The system of claim 1, wherein the computer executable instructions cause the processor to perform further operations to:
receive update user data from the one or more databases, wherein the updated user data is different from the user data; and
analyze, via the machine learning model, the updated user data to determine whether to update a current recommended plan or to generate a new recommended plan.

3. The system of claim 2, wherein the computer executable instructions cause the processor to perform further operations to:
determine, via the machine learning model, from the updated user data, that the circumstances of the user has changed sufficiently to warrant an update of a current transfer schedule; and
generate, via the machine learning model, a new transfer schedule based on the goal value, the target date, the user data and the plan template used to generate the recommended plan, wherein the new transfer schedule is different from the transfer schedule of the current recommended plan.

4. The system of claim 3, wherein the computer executable instructions cause the processor to perform further operations to:
display a notification on a user interface before the user, wherein the notification informs the user that the recommended plan remains the same, and indicates that the current transfer schedule is being replaced by the new transfer schedule.

5. The system of claim 2, wherein the computer executable instructions cause the processor to perform further operations to:
determine, from the updated user data, that the circumstances of the user has changed sufficiently to warrant a new recommended plan;
generate, via a machine learning model, one or more new plan options based on the updated user data and the one or more plan templates, wherein each new plan option is associated with a new transfer schedule that indicates one or more new specific amount of resources to be transferred from the first user account to the second user account at one or more new predetermined time intervals until the goal value is completed by a new target date; and
determine, via the machine learning model, a new confidence score for each new plan option based on the updated user data and the associated new transfer schedule, wherein the new recommended plan is based on the plan option having the highest confidence score.

6. The system of claim 1, wherein the computer executable instructions cause the processor to perform further operations to:
display a notification on a user interface before the user, wherein the notification informs the user that the current recommended plan is being replaced by a new recommended plan.

7. The system of claim 1, wherein the computer executable instructions cause the processor to perform further operations to:
determine that the objective has been fulfilled after completion of the one or more conditions;
display a notification on a user interface before the user that the user has fulfilled the objective by completing the one or more conditions associated with the objective.

8. A non-transitory computer-readable medium including computer-executable instructions that, when executed by a computing device, causes the computing device to:
receive instructions, from a user, to generate a recommended plan based on an objective that is fulfilled after completion of one or more conditions, wherein the one or more conditions include a goal value and a target date of fulfilling the objective;
retrieve user data from one or more databases;
generate, via a machine learning model, one or more plan options based on the user data and one or more plan templates, wherein each plan option is associated with a transfer schedule that indicates one or more specific amount of resources to be transferred from a first user account to a second user account at one or more predetermined time intervals until the goal value is completed by the target date;
determine, via the machine learning model, a confidence score for each plan option based on the user data and the associated transfer schedule, wherein the confidence score is associated with a probability that the user is capable of fulfilling the objective by adhering to the transfer schedule in the plan option;
implement the recommended plan by moving resources from the first user account to the second user account according to the transfer schedule associated with the recommended plan until the objective is fulfilled, wherein the recommended plan is the plan option having the highest confidence score among the one or more plan options; and
display planning graphics associated with the recommended plan, wherein the planning graphics includes a chart indicating a predicted total amount of resources accumulated in the second user account for each of the one or more predetermined time intervals and the one or more specific amount of resources that are predicted to be transferred to the second user account for each of the one or more predetermined time intervals.

9. The non-transitory computer-readable medium of claim 8, wherein the computer executable instructions cause the computing device to perform further operations to:
display, after the one or more plan options are generated by the machine learning model, the one or more plan options on a user interface before the user, wherein the one or more displayed plan options include a confidence score associated with each plan option, wherein a plan option with the highest confidence score is indicated to the user as the recommended plan.

10. The non-transitory computer-readable medium of claim 9, wherein the computer executable instructions cause the computing device to perform further operations to:
receive instructions from the user to select at least one of the one or more plan options displayed on the user interface before the user; and
determine the recommended plan as the plan option selected by the user.

11. The non-transitory computer-readable medium of claim 8, wherein a first plan option of the one or more plan options is based on a first plan template, and wherein a transfer schedule determined based on the first plan template indicates that the specific amount of resources to be moved from the first user account to the second user account is to increase according to a predetermined increment for each of the one or more predetermined time intervals.

12. The non-transitory computer-readable medium of claim 8, wherein a second plan option of the one or more plan options is based on a second plan template, and wherein a transfer schedule determined based on the second plan template indicates that the one or more specific amount of resources to be moved from the first user account to the second user account is to be at a fixed value for each of the one or more predetermined time intervals.

13. The non-transitory computer-readable medium of claim 8, wherein a third plan option of the one or more plan options is based on a third plan template, wherein a transfer schedule determined based on the third plan template indicates that the specific amount of resources to be moved from the first user account to the second user account is to increase according to first rate for each of the one or more predetermined time intervals until the objective is fulfilled, and to be increased according to a second rate for each of the one or more predetermined time intervals after the objective is fulfilled.

14. The non-transitory computer-readable medium of claim 8, wherein the machine learning model is at least one of a long short-term memory (LSTM) model that is incorporated with a hidden Markov Model (HMM).

15. A computerized method for generating a plan to automatically fulfill a goal associated with a user, the method comprising:
receiving instructions, from the user, to generate a recommended plan based on an objective that is fulfilled after completion of one or more conditions, wherein the one or more conditions include a goal value and a target date of fulfilling the objective;
retrieving user data from one or more databases;
generating, via a machine learning model, one or more plan options based on the user data and one or more plan templates, wherein each plan option is associated with a transfer schedule that indicates one or more specific amount of resources to be transferred from a first user account to a second user account at one or more predetermined time intervals until the goal value is completed by the target date;
determining, via the machine learning model, a confidence score for each plan option based on the user data and the associated transfer schedule, wherein the confidence score is associated with a probability that the user is capable of fulfilling the objective by adhering to the transfer schedule in the plan option;
implementing the recommended plan by moving resources from the first user account to the second user account according to the transfer schedule associated with the recommended plan until the objective is fulfilled, wherein the recommended plan is the plan option having the highest confidence score among the one or more plan options; and
displaying planning graphics associated with the recommended plan, wherein the planning graphics includes a chart indicating a predicted total amount of resources accumulated in the second user account for each of the one or more predetermined time intervals and the one or more specific amount of resources that are predicted to be transferred to the second user account for each of the one or more predetermined time intervals.

16. The computerized method of claim 15, wherein the chart of the planning graphics is at least one of a line graph, pie chart, table, scatter plot, histogram, area chart, Gannt chart, column chart, bullet graph, and box plot.

17. The computerized method of claim 15, wherein the one or more user databases includes a user information database that stores user information that is associated with the user.

18. The computerized method of claim 17, wherein the user information stored in the user information database includes at least one of one or more other objectives that are associated with the user, and one or more routines that are associated with the user.

19. The computerized method of claim 15, wherein the one or more user databases includes a user account database that stores one or more user accounts that are associated with the user, wherein each user account includes user data associated with the user.

20. The computerized method of claim 19, wherein the user account data includes transactions performed with respect to the user accounts, which includes at least one of deposits, withdrawals, purchases, utility bill payments, subscription payments, loan payments, and credit card payments.
